(19) United States
(12) Patent Application Publication
(10) Pub. No.: US 2014/0127030 A1
(43) Pub. Date: May 8, 2014

(54) A TURBINE BLADE SYSTEM

(71) Applicant: NEW WORLD ENERGY ENTERPRISES LTD, Longford (IE)

(72) Inventors: James SMYTH, County Cavan (IE); Gerard SMYTH, County Longford (IE); Andrew SMYTH, County Armagh (IE); David SMYTH, County Longford (IE); Peter SMYTH, County Longford (IE)

(21) Appl. No.: 14/059,923

(22) Filed: Oct. 22, 2013

(30) Foreign Application Priority Data
Oct. 22, 2012 (IE) S2012/0466

(51) Int. Cl. F03D 1/06

(52) U.S. Cl. CPC F03D 1/0675
USPC 416/237

(57) ABSTRACT

A wind turbine blade system having a main blade having a root and a tip, and at least one secondary blade secured to or formed integrally with the main blade about the tip, the at least one secondary blade being shaped and dimensioned to form, when the main blade is rotated, a shroud circumscribing a swept area of the main blade in order to improve the airflow past the main blade during operation of the wind turbine.

### REFERENCE TO RELATED APPLICATION

This application claims priority to Irish Patent Application No. S2012/0466, filed Oct. 22, 2012, the disclosure of which is incorporated herein by reference.

### FIELD OF THE INVENTION

This invention relates to a turbine blade system, and in particular a turbine blade system for use in a fluid powered turbine such as a wind turbine, and which is modified such as to generate, during rotation, a virtual or effective shroud circumscribing the swept area of one or more main blades of the system in order to improve the airflow past the main blade(s) during operation.

### BACKGROUND OF THE INVENTION

The use of wind turbines in recent decades has seen a significant increase due primarily to concerns over fossil fuel shortages and the damage to our environment from the use of such fossil fuels.

Wind turbine technology has therefore seen significant advancements, both in the efficiency of such turbines, the materials chosen for manufacture, and the viable locations at which such turbines can be installed, for example off shore, or at previously unsuitable sights due to technological improvements.

Nevertheless, there is a limit to the total wind power which can be captured by a wind turbine, the maximum achievable being 59% of the maximum theoretical wind power, which is also known as the bets limit or bets law. However in practice most wind turbines achieve peak power extraction of approximately 75 to 80% of the bets limit.

The bets limit is based on an open bladed design of wind turbine, and can be overcome by locating a shroud and/or diffuser about the turbine blades, in order to direct additional wind flow past the blades of the turbine. However the addition of such shrouds and/or diffusers adds to both the cost and complexity of the wind turbine, and as a result such additions are not widespread.

It is therefore an object of the present invention to overcome the above mentioned problem.

### SUMMARY OF THE INVENTION

According to a first aspect/embodiment of the invention, there is provided a turbine blade system comprising at least one main blade having a root and a tip; and at least one secondary blade secured to or formed integrally with the main blade about the tip.

Preferably, the at least one secondary blade is shaped and dimensioned to form, when the main blade is rotated, a shroud circumscribing a swept area of the main blade.

Preferably, the at least one main blade comprises an aerofoil section such as to generate torque during rotation in response to the passage of a working fluid.

Preferably, the at least one secondary blade comprises an aerofoil section such as to generate torque during rotation in response to the passage of a working fluid.

Preferably, the secondary blade is substantially non coplanar with a plane of rotation of the main blade.

Preferably, the main blade and secondary blade are separated from one another by a gap.

Preferably, the at least one secondary blade is dimensioned to extend upstream of a leading edge of the main blade and downstream of a trailing edge of the main blade.

Preferably, a leading edge of the main blade is substantially parallel to a leading edge of the at least one secondary blade.

Preferably, a trailing edge of the main blade is substantially parallel to a trailing edge of the at least one secondary blade.

Preferably, a suction surface of the at least one secondary blade is non coplanar with a suction or upper surface of the main blade.

Preferably, the turbine blade system comprises a plurality of secondary blades.

Preferably, the plurality of secondary blades are arranged in series, adjacent secondary blades being separated from one another by a gap.

Preferably, each secondary blade has a different chord length than, in a direction towards the tip of the main blade, the immediately adjacent secondary blade.

Preferably, each secondary blade has a different average width than, in a direction towards the tip of the main blade, the immediately adjacent secondary blade.

Preferably, each secondary blade has a reduced mass than, in a direction towards the tip of the main blade, the immediately adjacent secondary blade.

Preferably, the plurality of secondary blades are arranged such that a suction or upper surface of the secondary blades define a stepped slope with respect to a suction or upper surface of the main blade.

Preferably, the plurality of secondary blades are arranged such that the suction surfaces of the secondary blades are substantially parallel to one another and to the suction surface of the main blade.

Preferably, the plurality of secondary blades are arranged such that the suction surfaces of the secondary blades are substantially parallel to one another and at an angle to the suction surface of the main blade.

Preferably, the at least one secondary blade reduces in thickness in a direction towards the main blade.

Preferably, at least one of the secondary blades is formed integrally with the main blade.

Preferably, the turbine blade system comprises a shrouding blade set comprising a plurality of the main and secondary blades which form, when rotated, a shroud circumscribing a swept area of the main blades, and a plurality of shrouded blades positioned coaxially of, and axially offset relative to, the main blades such as to be disposed, in use, within the shroud.

Preferably, the shrouding blade set comprises a circular array of the main and secondary blades, and the shrouded blade set comprises a circular array of the shrouded blades disposed at an angular offset to the main blades.

Preferably, at least one of the blades has a plurality of dimples distributed over an area of at least one surface of the blade which extends from at or adjacent a leading edge of the blade at least partially towards a trailing edge of the blade.

According to a second aspect/embodiment of the present invention, there is provided a wind turbine comprising at least one blade system according to the first aspect of the invention.

Preferably, the wind turbine comprises a shroud and/or diffuser mounted about the at least one blade system.

Preferably, the shrouded blades are located, in use, upstream of the shrouding blades.

As used herein, the terms “upstream” and “downstream” are intended to mean, respectively, a position upstream of a blade of a turbine with respect to, in use, the direction of flow of the prevailing fluid flow driving rotation of the blade, and a position downstream of such a prevailing fluid flow.

Various other objects, advantages and features of the present invention will become readily apparent to those of ordinary skill in the art, and the novel features will be particularly pointed out in the appended claims.

### BRIEF DESCRIPTION OF THE DRAWINGS

Various embodiments of the present invention will now be described with reference to the accompanying drawings, in which:

FIG. 1 illustrates a perspective view of a turbine blade system according to an embodiment of the present invention;

FIG. 2 illustrates a front elevation of the blade system illustrated in FIG. 1;

FIG. 3 illustrates an enlarged view of a portion of the blade system as illustrated in FIG. 2;

FIG. 4 illustrates an end view of the blade system of FIGS. 1 to 3;

FIG. 5 illustrates an enlarged perspective view of a portion of the blade system shown in FIGS. 1 to 4;

FIG. 6 illustrates a perspective view of a turbine blade system according to an alternative embodiment of the present invention;

FIG. 7 illustrates a front elevation of the blade system illustrated in FIG. 6;

FIG. 8 illustrates a front elevation of a further alternative embodiment of a turbine blade system according to the present invention; and

FIG. 9 illustrates a side elevation of the blade system shown in FIG. 8.

### DETAILED DESCRIPTION OF THE DRAWINGS

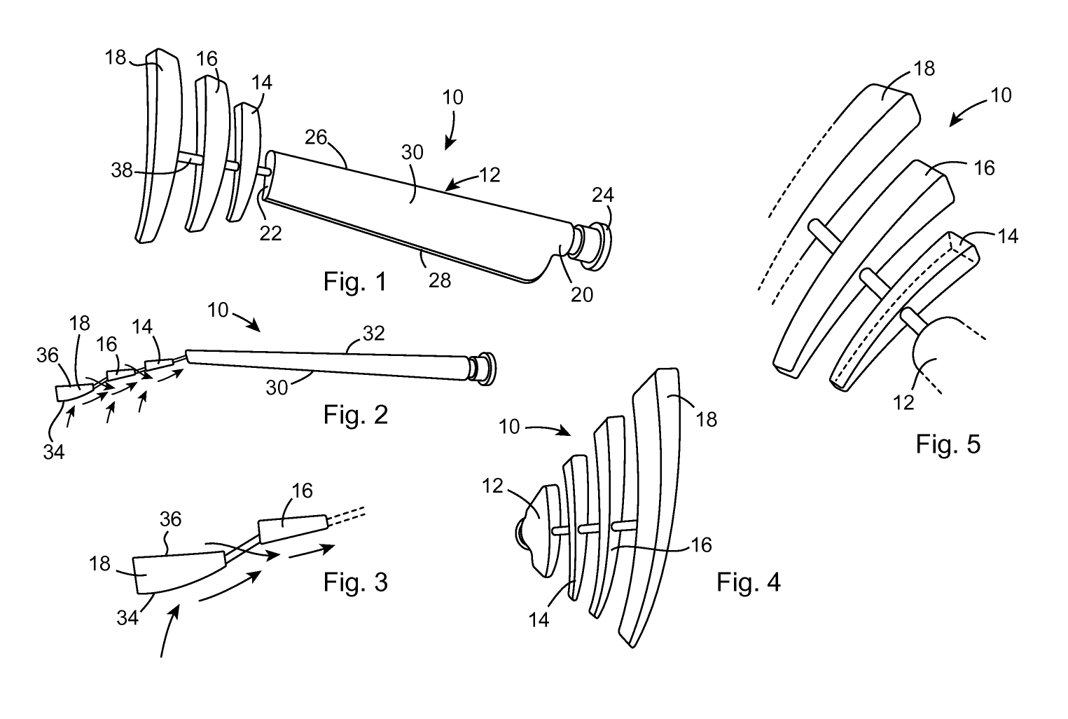

Referring now to FIGS. 1 to 5 of the accompanying drawings, there is illustrated a turbine blade system, generally indicated as 10, for particular use in fluid powered turbines such as wind turbines, although the blade system 10 may have alternative applications.

The blade system 10 comprises a main blade 12 which is substantially conventional in design, having an aerofoil section in order to generate lift in response to the passage of air or other working fluid across the main blade 12. The system 10 further comprises at least one, and in the embodiment illustrated first second and third secondary blades 14, 16, 18 secured to or formed integrally with the main blade 12, as will be described in greater detail hereinafter. These secondary blades 14, 16, 18 are adapted to increase, in use, the airflow across the main blade 12 while also, due to an aerofoil cross section, generating their own lift in order to supplement the lift and therefore torque generated by the main blade 12.

The main blade 12 comprises a root 20 and a tip 22 at the opposed end thereof, the root 20 being provided, in the embodiment illustrated, with a coupling 24 in order to allow the main blade 12 to be secured to a hub/nacelle (not shown) of a wind turbine, although any other suitable mounting may be provided. The main blade 12 comprises an aerofoil section extending between a leading edge 26 and a trailing edge 28, and thus defining a suction or upper surface 30 and a pressure or lower surface 32, together the “working surfaces” of the main blade 12. The area of the working surfaces decreases towards the tip 22 in conventional fashion. Although the main blade 12 may be designed with some twist about a longitudinal axis in order to optimize the aerodynamics for variable wind speeds, for the purposes of the present application the main blade 12 can be considered as being substantially planar in form, with the suction and pressure surfaces 30, 32 lying substantially perpendicular to the working plane of the main blade 12. This working plane may also be defined as the plane of rotation of the main blade 12 during normal operation, also known as the “rotor disc”.

The secondary blades 14, 16, 18 are located adjacent and radially outwardly of the tip 22 of the main blade 12 with respect to an axis of rotation (not shown) of the main blade 12 during use. Adjacent secondary blades 14, 16, 18 are separated from one another by a gap, the reasons for which will be explained in detailed hereinafter. The secondary blades 14, 16, 18 are preferably oriented such that a suction surface 34 and a pressure surface 36 of each of the secondary blades 14, 16, 18 lie substantially parallel but offset to the working surfaces of the main blade 12, and so in use are raised out of the plane of the rotor disc formed by the main blade 12. In the embodiment illustrated the secondary blades 14, 16, 18 are arranged in a stepped slope relative to the main blade 12, preferably extending progressively upwardly out of the plan of the main blade 12 with distance from the tip 22, such that the secondary blades 14, 16, 18 will lead the main blade 12 during rotation of the main blade 12.

The secondary blades 14, 16, 18 are also dimensioned such as to extend, relative to the direction of airflow across the main blade 12, upstream of the leading edge 26 and downstream of the trailing edge 28. The leading and trailing edges 26, 28 of the secondary blades 14, 16, 18 are preferably substantially parallel with the leading edge 26 and trailing edge 28 respectively of the main blade 12. In addition, each of the secondary blades 14, 16, 18 preferably has an increased cord length than the adjacent secondary blade 14, 16, 18 with progressive distance from the tip 22 of the main blade 12. However, it is also envisaged that this arrangement could be reversed, whereby each of the secondary blades 14, 16, 18 has a decreased chord length than the adjacent secondary blade 14, 16, 18 with progressive distance from the tip 22 of the main blade.

Furthermore each secondary blade 14, 16, 18 has an increased width than the immediately adjacent secondary blades 14, 16, 18 with progressive distance from the tip 22 of the main blade 12. However, as with the chord length, it is also envisaged that this arrangement could be reversed, whereby each of the secondary blades 14, 16, 18 has a decreased width than the adjacent secondary blade 14, 16, 18 with progressive distance from the tip 22 of the main blade. Each of the secondary blades 14, 16, 18 also preferably tapers inwardly in width from the leading edge towards the trailing edge, as is clearly visible from FIG. 5, and taper inwardly in thickness from a distal edge to a proximal edge relative to the tip 22, such that the suction surface 34 and pressure surface 36 converge towards one another in a direction towards the tip 22 of the main blade 12, as visible for example in FIG. 3. The secondary blades 14, 16, 18 preferably also reduced in mass with progressive distance from the tip 22 of the main blade 12. In addition, each of the secondary blades 14, 16, 18 preferably also has a greater blade solidity or solidity factor with respect to the main blade 12. Blade solidity is defined as the ratio of blade chord length to pitch.

The secondary blades 14, 16, 18 are secured to one another and to the main blade 12 by means of a support 38 extending from the main blade 12 through each of the secondary blades 14, 16, 18. It will of course be appreciated that any other suitable means of securing the secondary blades 14, 16, 18 in position may be employed.

Turning then to the operation of the turbine blade system 10, the main blade 12 is secured to the hub/nacelle (not shown) of a conventional wind turbine (not shown). The blade system 10 may however be used with a wind turbine to which a shroud and/or diffuser are fitted in order to further increase and/or augment the flow of air past the blades of the turbine. In use multiple main blades 12 will be employed, the most common design of wind turbine employing a circular array of three equally spaced and radially extending blades. The main blade 12 is positioned such that the leading edge 26 faces into the oncoming wind or other working fluid while the trailing edge 28 faces away. In this way wind passes across the suction surface 30 and pressure surface 32, the airfoil section of the main blade 12 generating a pressure differential between these opposed working surfaces of the main blade 12, thereby generating lift. This generated lift causes the blade system 10 to rotate in order to form a rotor disc, which generates a torque at the axle (not shown) of the nacelle on which the blade system 10 is mounted.

This results in a corresponding rotation of the secondary blades 14, 16, 18 whose shape and position will therefore result in the formation of an effective or “virtual” shroud circumscribing the rotor disc. As each of the secondary blades 14, 16, 18 extends upstream of the leading edge 26 of the main blade 12, and preferably downstream of the trailing edge 28, when rotated the secondary blades 14, 16, 18 form a convergent divergent shroud when viewed in a direction parallel to the axis of rotation of the main blade 12. This virtual shroud serves to augment and accelerate the airflow across the main blades 12, thereby allowing additional power to be generated. This is due to the increased air resistance at the radially outermost secondary blade 18, which will thus force the air flowing past the secondary blade 18 radially inwardly to take the path of least resistance.

In a normal wind turbine blade, or for example the main blade 12 in the absence of the secondary blades 14, 16, 18, as the surface area of the working surfaces reduces towards the tip 22, the air flowing over the blade 12, in particular in the region of the tip 22, will move towards and over the tip 22 due to the region of lower pressure radially beyond the tip 22. However, the presence of the secondary blades 14, 16, 18, which give rise to an increasing surface area of the working surfaces in a direction radially outward of the tip 22, generating a region of increased pressure beyond the tip 22. This results in the airflow or other working fluid being forced radially inwardly back toward the main blade 12, increasing the lift and torque generated by the main blade 12.

This process reduces the amount of boundary layer separation that would occur at the main blade 12 in the absence of the secondary blades 14, 16, 18. The tapering thickness of the secondary blades 14, 16, 18, whereby the suction surface 34 and pressure surface 36 converge towards one another in a direction toward the tip 22, as most clearly visible in FIG. 3, results in a lateral or radially inward flow of air across the working surfaces of the secondary blades 14, 16, 18, thus displacing a substantial portion of the airflow past the secondary blades 14, 16, 18 inwardly towards the main blade 12. The gap between adjacent secondary blades 14, 16, 18 allows this radially inwardly flowing air to pass through the respective gap towards the adjacent secondary blade 14, 16, thereby mixing with the air moving width wise across the suction surface 34 of said adjacent secondary blade 14, 16. This mixing accelerates the airflow towards the main blade 12.

In addition to the above, the aerofoil section of each of the secondary blades 14, 16, 18 results in lift being generated by each of the secondary blades 14, 16, 18, which adds torque to the rotation of the main blade 12, again increasing the power produced by the blade system 10.

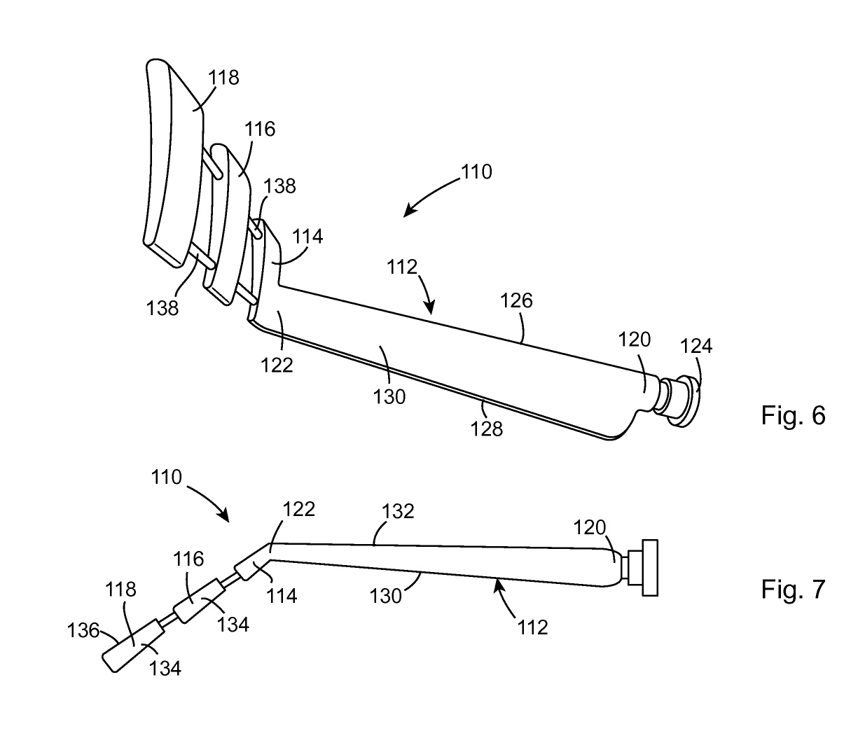

Referring now to FIGS. 6 and 7 there is illustrated a turbine blade system according to an alternative embodiment of the present invention, generally indicated as 110. In this alternative embodiment like components have been accorded like reference numerals and unless otherwise stated perform a like function.

The blade system 110 comprises a main blade 112 and a plurality of secondary blades 114, 116, 118. The main blade 112 comprises a root 120 and a tip 122, the root 120 having a coupling 124 to allow the main blade 112 to be secured, for example, to a hub/nacelle (not shown) of a conventional wind turbine. As with the first embodiment the blade system 110 may be used with a wind turbine to which a fixed physical shroud and/or diffuser is fitted. The main blade 112 defines a leading edge 126 and a trailing edge 128, between which extend a suction surface 130 and a pressure surface 132 forming the working surfaces of the main blade 112. The main blades 112 are arranged to be positioned such that the leading edge 126 faces, in use, into the oncoming fluid flow whose passage around the suction and pressure surfaces 130, 132 generates lift as a result of the aerofoil section of the main blade 112. This lift produces a torque at the hub/axle to which, in use, the blade system 110 is mounted, in order to generate power.

The secondary blades 114, 116, 118 extend radially outwardly from a tip 122 of the main blade 112, but at an angle to a plane of the main blade 112. In this embodiment a suction surface 134 and pressure surface 136 of the secondary blades 114, 116, 118 are substantially parallel to one another, but are disposed at an angle to the suction surface 130 and pressure surface 132 of the main blade 112. Thus it can be said that the secondary blades 114, 116, 118 form a linear slope with respect to the main blade 112, unlike the stepped slope of the first embodiment. The secondary blades 114, 116, 118 are secured to one another and the main blade 112 by means of a pair of supports 138, and adjacent secondary blades 114, 116, 118 as separated from one another by a gap. Unlike in the first embodiment, the first secondary blade 114 is formed integrally with the main blade 112 at the tip 122.

The secondary blades 114, 116, 118 again increase in chord length with progressive distance from the tip 122 of the main blade 112, in addition to decreasing in mass and increasing in width with progressive distance from the tip 122. The secondary blades 114, 116, 118 also taper in width and thickness as in the first embodiment.

The blade system 110 operates in the same manner as the blade system 10 of the first embodiment, with the secondary blades 114, 116, 118 forming a virtual shroud circumscribing the rotor disc during operation, and forcing airflow towards the main blade 112 while simultaneously increasing torque through lift generated by each of the secondary blades 114, 116, 118. This is as a result of the secondary blades 114, 116, 118 being positioned such that the leading edges face, in use, into the oncoming fluid flow whose passage around the suction and pressure surfaces of the secondary blades 114, 116, 118 generates lift due to the aerofoil section of the blades. This lift produces a torque at the hub/axle to which, in use, the blade system 110 is mounted, thereby adding to the torque produced by the main blades 112.

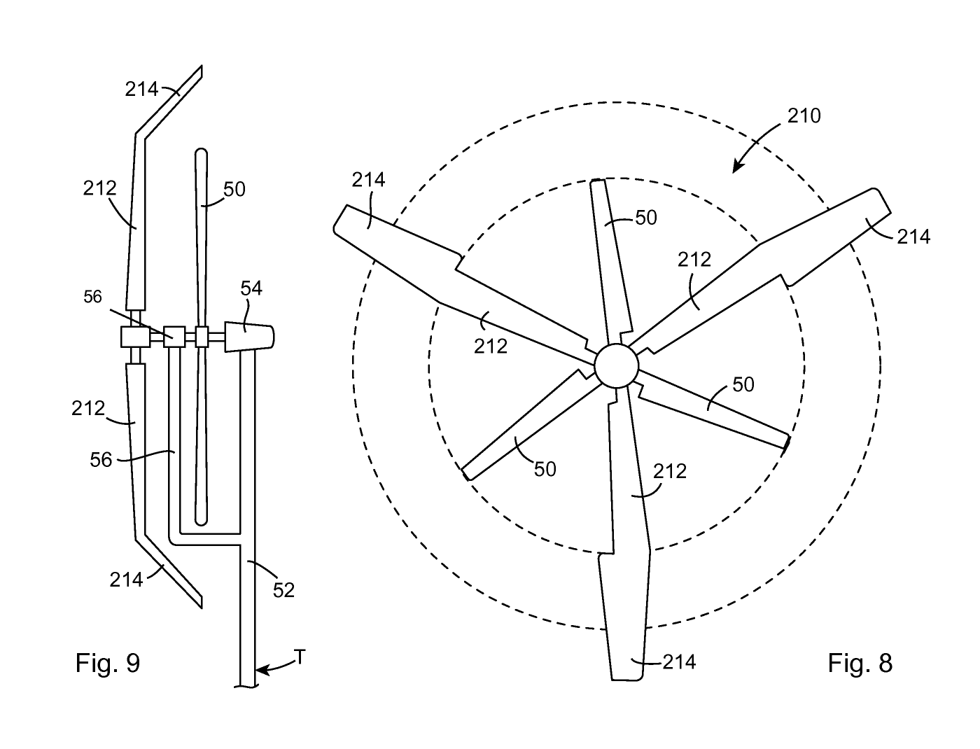

Referring now to FIGS. 8 and 9 there is illustrated a turbine blade system according to a further alternative embodiment of the present invention, generally indicated as 210. In this alternative embodiment like components have been accorded like reference numerals and unless otherwise stated perform a like function.

The blade system 210 comprises a plurality of main blades 212 and a plurality of corresponding secondary blades 214, each extending from at or adjacent a tip of a respective one of the main blades 212. The main and secondary blades 212, 214 are illustrated in a three blade circular array, although it will of course be appreciated that the number and positioning of the blades may be varied as required.

Although shown schematically in FIGS. 8 and 9 that each main blade 212 is provided with a single one piece secondary blade 214, it is to be understood that the secondary blades 214 may in fact be provided in multiple sections separated from one another by a respective gap, as described and shown with reference to the first and second embodiments of the invention. It can be seen, in particular from FIG. 9, that the secondary blades 214 are oriented out of the plane of rotation of the main blades 212, as hereinbefore described with reference to the earlier embodiments. As with these earlier embodiments, both the main blades 212 and the secondary blades 214 have an aerofoil cross section in order to generate lift and therefore torque in response to the passage of a working fluid, in particular the flow of air in the form of wind, passed the blade system 210. This will result in rotation of the blade set 210 and the generation of power, which may be converted into, for example, electric energy or mechanical power. It addition to the torque generated by the secondary blades 214, rotation thereof also results in the generation of a virtual shroud circumscribing the main blades 212 and acting to funnel or direct an increased volume of the working fluid past the main blades 212, thereby increasing the power output.

In order to extract additional power from the increased volume of the working fluid flowing through the virtual shroud generated by the secondary blades 214, the blade system 210 preferably additionally comprises a set of shrouded blades 50 which are, in use, located coaxially of the main blades 212 and axially offset, preferably upstream of, the main blades 212. In this way the array of main blades 212 and respective secondary blades 214 form a shrouding blade set, while the shrouded blades 50 define a shrouded blade set which is disposed, in use, within the virtual shroud generated by rotation of the secondary blades 214.

As a result the shrouded blades 50 will benefit from the increased fluid flow resulting from the generation of the virtual shroud. While the shrouded blades 50 are shown, for example in FIG. 9, axially offset upstream of the main blades 212 such as to be fully contained within the virtual shroud generated by the secondary blades 214, it is to be understood that the shrouded blades 50 may be located at any distance relative to the main blades 212 such as to be positioned within the field or sphere of influence of the virtual shroud generated, such as to benefit from the increased fluid flow.

As with the main and secondary blades 212, 214, the shrouded blades 50 are provided, in the embodiment illustrated, in a three blade circular array which is angularly offset to the main blades 212 such that each shrouded blade 50 is disposed an equal distance between the pair of main blades 212 disposed on either side thereof. It will again be understood that the number and positioning of the shrouded blades 50 may be altered as required.

The blade system 210 illustrated in FIGS. 8 and 9 preferably forms part of a wind turbine T having a substantially conventional mast 52 to which a hub or nacelle 54 is fixed in known fashion. In order to provide structural integrity to the two sets of blades, the mast 52 may comprise a secondary support 56 to which the nacelle 54 is also secured. In this way the main and secondary blades 212, 214 may be mounted downstream of the secondary support 56, with the set of shrouded blades 50 captured between the secondary support 56 and the main portion of the mast 52. It will of course be appreciated that any other suitable arrangement may be provided in order to retain the two sets of blades at the desired relative positions. The turbine T may be arranged such that the shrouding blade set, although mounted co-axially with the shrouded blade set, may rotate at a lesser velocity (RPM) than the shrouded blade set. This may be achieved by means of a suitable gearbox 58 disposed between the shrouded blade set and the shaft on which the blade sets are mounted. In this way the shrouding blades can rotate at a lesser RPM but through the step-up gearbox 58 the excess torque can be converted to RPM and transferred back to the shaft. A clutch mechanism may also be disposed between the gearbox 58 and shaft to ensure that the excess torque is only transferred to the shaft in one direction. This excess torque (power) on the shaft could also be stored by means of a flywheel (not shown) mounted to the shaft.

Suitable pitch and or yaw mechanisms may also be provided as part of the wind turbine T.

In addition, one or more of the blades of the blade system 10, 110, 210, including the shrouding blade set and/or the shrouded blade set, may include surface features to augment the flow of working fluid past the blades, in order, preferably, to increase the power output of the blades in use. For example one or more of the blades may have a plurality of dimples distributed over an area of at least one surface of the blade which extends from at or adjacent a leading edge of the blade at least partially towards a rear edge of the blade, as described and shown in Applicant's co-pending International patent application No. PCT/EP2013/066495, the relevant details of which are incorporated herein by reference.

The blade system 10; 110; 210 of the present invention thus provides a mechanism by which the blades of a wind turbine or the like can be modified in order to generate a virtual shroud surrounding the blades during use, in order to increase the airflow past the blades, without requiring the provision of a permanent shroud circumscribing the blades of the turbine.

The present invention is not limited to the embodiment(s) described herein, which may be amended or modified without departing from the scope of the present invention.

Therefore, it is intended that the appended claims be interpreted as including the embodiments described herein, the alternatives mentioned above, and all equivalents thereto.

What is claimed is:

1. A turbine blade system comprising at least one main blade having a root and a tip; and at least one secondary blade secured to or formed integrally with the main blade about the tip.

2. A turbine blade system according to claim 1, in which the at least one secondary blade is shaped and dimensioned to form, when the main blade is rotated, a shroud circumscribing a swept area of the main blade.

3. A turbine blade system according to claim 1, in which the at least one main blade comprises an aerofoil section such as to generate torque during rotation in response to the passage of a working fluid.

4. A turbine blade system according to claim 1, in which the at least one secondary blade comprises an aerofoil section such as to generate torque during rotation in response to the passage of a working fluid.

5. A turbine blade system according to claim 1, in which the at least one secondary blade is substantially non coplanar with a plane of rotation of the main blade.

6. A turbine blade system according to claim 1, in which the main blade and the at least one secondary blade are separated from one another by a gap.

7. A turbine blade system according to claim 1, in which the at least one secondary blade is dimensioned to extend upstream of a leading edge of the main blade and downstream of a trailing edge of the main blade.

8. A turbine blade system according to claim 1, in which a leading edge of the main blade is substantially parallel to a leading edge of the at least one secondary blade.

9. A turbine blade system according to claim 1, in which a trailing edge of the main blade is substantially parallel to a trailing edge of the at least one secondary blade.

10. A turbine blade system according to claim 1, in which a suction or upper surface of the at least one secondary blade is non coplanar with a suction surface of the main blade.

11. A turbine blade system according to claim 1, comprising a plurality of secondary blades.

12. A turbine blade system according to claim 11, in which the plurality of secondary blades are arranged in series, adjacent secondary blades being separated from one another by a gap.

13. A turbine blade system according to claim 11, in which each secondary blade has a different chord length than, in a direction towards the tip of the main blade, an immediately adjacent secondary blade.

14. A turbine blade system according to claim 11, in which each secondary blade has a different average width than, in a direction towards the tip of the main blade, an immediately adjacent secondary blade.

15. A turbine blade system according to claim 11, in which each secondary blade has a reduced mass than, in a direction towards the tip of the main blade, an immediately adjacent secondary blade.

16. A turbine blade system according to claim 11, in which the plurality of secondary blades are arranged such that a suction or upper surface of the secondary blades define a stepped slope with respect to a suction or upper surface of the main blade.

17. A turbine blade system according to claim 16, in which the plurality of secondary blades are arranged such that the suction surfaces of the secondary blades are substantially parallel to one another and to the suction surface of the main blade.

18. A turbine blade system according to claim 16, in which the plurality of secondary blades are arranged such that the suction surfaces of the secondary blades are substantially parallel to one another and at an angle to the suction surface of the main blade.

19. A turbine blade system according to claim 1, in which the at least one secondary blade reduces in thickness in a direction towards the main blade.

20. A turbine blade system according to claim 1, in which at least one of the secondary blades is formed integrally with the main blade.

21. A turbine blade system according to claim 1, comprising a shrouding blade set comprising a plurality of the main and secondary blades which form, when rotated, a shroud circumscribing a swept area of the main blades, and a plurality of shrouded blades positioned coaxially of, and axially offset relative to, the main blades such as to be disposed, in use, within the shroud.

22. A turbine blade system according to claim 21, in which the shrouding blade set comprises a circular array of the main and secondary blades, and the shrouded blade set comprises a circular array of the shrouded blades disposed at an angular offset to the main blades.

23. A turbine blade system according to claim 1, in which at least one of the blades has a plurality of dimples distributed over an area of at least one surface of the blade which extends from at or adjacent a leading edge of the blade at least partially towards a trailing edge of the blade.

24. A wind turbine comprising at least one blade system according to claim 1.

25. A wind turbine according to claim 24, comprising a shroud and/or diffuser mounted about the at least one blade system.

26. A wind turbine comprising at least one blade system according to claim 21, in which the shrouded blades are located, in use, upstream of the shrouding blades.
